(19) United States
(12) Patent Application Publication
(10) Pub. No.: US 2006/0143616 A1
(43) Pub. Date: Jun. 29, 2006

(54) System and method for performing multi-task processing

(75) Inventors: Tomotake Koike, Tokyo (JP); Tomokazu Ando, Tokyo (JP)

Correspondence Address: VENABLE LLP, P.O. BOX 34385, WASHINGTON, DC, 20045-9998, US

(73) Assignee: Oki Electric Industry Co., Ltd., Tokyo (JP)

(21) Appl. No.: 11/313,750

(22) Filed: Dec. 22, 2005

(30) Foreign Application Priority Data
Dec. 28, 2004 (JP) 2004-379909

(51) Int. Cl. G06F 9/46

(52) U.S. Cl. 718/102

(57) ABSTRACT

The present invention provides a technique for improving the processing efficiency of a processor in a multi-tasking processing system. A first scheduler generates an event processing unit by linking one or a plurality of events that are capable of being executed by the system under the same context. A second event scheduler performs processing of events that are included in the event processing unit created by the first event scheduler and processing that performs event switching not accompanied by context switching when processing of each event is terminated. A time-sharing system scheduler causes a processor to execute as tasks respectively the operation of the first and second event schedulers. The processing efficiency of the processor is improved by executing event switching not accompanied by context switching by the first and second event schedulers.

### BACKGROUND OF THE INVENTION

1. Field of the Invention

The present invention relates to a system and method for performing multi-task processing. The system and method according to the present invention are realized using a computer installed a multi-tasking operating system. The present invention can be applied, for example, to a Voice over Internet Protocol (VoIP) software switch constructed using such a computer i.e. a switch for Internet telephony constructed by software on a computer.

2. Description of Related Art

Known examples of multi-tasking operating systems include Windows (Registered Trademark) and Linux (Registered Trademark) A multi-tasking operating system includes a kernel. The kernel is the software that implements the basic functions of the operating system. The kernel monitors for example the application software, peripheral devices and memory. In addition, the kernel implements for example interrupt processing and inter-process communication.

In addition, the kernel of a multi-tasking operating system comprises a time-sharing system. A time-sharing system is disclosed in the following reference:—

“Introduction to OS for understanding Linux and Windows” by Tsutomu Sawada, Ayako Sawada and Masatake Nagai, published by Kyoritsu Shuppan Co. Ltd, November 2003, pp 126 to 130.

A time-sharing system is a program for executing a plurality of tasks in parallel on a single processor. A task is a unit of processing performed by a processor. The time-sharing system changes over the task that is being executed at intervals of a prescribed ‘time quantum’. In this way, the processor can execute a pluralityof tasks substantially in parallel. Usually, the time quantum is set at 8 to 10 milliseconds.

For example, in the case of Windows, a single task executes a single thread. A thread is a unit of program executed by a processor. In the case of a multi-tasking operating system of the type in which processes are not executed in thread units, a single task executes a single process. Hereinbelow, the description will be given taking the example of the case where a single task executes a single thread.

A time-sharing system has a TSS (Time-sharing System) scheduler. The TSS scheduler first of all commences execution of the initial task on the processor. Accompanying the execution of the task, for example data and a program are stored in the cache memory of the processor. When the processing time reaches the time quantum, the TSS scheduler interrupts the processor, stops execution of this task, and actuates the dispatcher.

The dispatcher performs context switching. The context is the execution environment of the thread. In context switching, the cache memory of the processor is flushed and information for executing another task is loaded into this cache memory. Flushing means that a cache memory region in which for example data is written is set to a condition in which other data or the like can be overwritten.

After this, the TSS scheduler causes the processor to commence execution of the next task. After all of the tasks have been executed at one ‘time quantum’, the TSS scheduler recommences execution of the initial task.

In some cases, execution of the task terminates before the lapsed time from commencement of execution reaches the time quantum. In such cases, the processor does nothing until the lapsed time reaches the time quantum, so the efficiency of processing is poor. Therefore, as a measure for decreasing the non-processing time of the processor, the TSS scheduler performs context switching even if the lapsed time has not reached the time quantum. As described above, in context switching, loading and flushing of the cache memory are performed. The time for which context switching monopolizes the processor is not so short as to be negligible. Consequently, if context switching occurs frequently, the efficiency of user processes cannot be sufficiently increased.

A stratagem for reducing the time during which the processor is not performing any processing that may easily be envisioned is the method of setting the time quantum to a short time. However, in this case also, the frequency of occurrence of context switching increases. Consequently, shortening the time quantum cannot sufficiently improve the processing efficiency of the processor.

The technical problem that the efficiency of processing cannot be increased since the time for which context switching monopolizes the processor is long becomes more severe as the number of threads that are processed in a time shorter than the time quantum becomes larger.

Threads frequently perform generation, alteration or perusal of resources. However, if a plurality of threads accesses the same resource region, consistency of the data is destroyed. For example, in the case where a certain thread, it is assumed thread A here, writes a resource region and at a latter time peruses this region, if another thread, it is assumed thread B here, writes other data into the resource region between the writing and the perusal by the first thread, erroneous processing by the thread A may result. It is therefore necessary to suspend processing by the thread B until the thread A completes its processing, when the thread B attempts to access the resource region where has been already accessed by the thread A. This function is called an “exclusion primitive” function. An exclusion primitive function is provided in substantially all multi-tasking operating systems. For example, one known type of exclusion primitive function is the mutual exclusion service (Mutex).

The exclusion primitive function does not guarantee the preferential processing of the thread that is in standby. That is, it is not necessarily the case that the thread that is in standby is immediately processed after completion of processing of the thread that had priority in utilizing the resource. There is therefore the risk that the exclusion primitive function may delay processing of the thread.

Also, although, if a thread that is using part of a resource region with priority is suspended by the exclusion primitive function, the resource region that is being utilized with priority by this suspended thread is not released. Consequently, other threads that attempt to access this resource region, in which a priority right was given to the suspended thread, will also be suspended by the exclusion primitive function. In this way, when the number of suspended threads increases, finally, deadlock may be occurred. Deadlock is a situation in which all tasks are suspended.

### SUMMARY OF THE INVENTION

An object of the present invention is to provide a system and method for improving the processing efficiency of the processor in a multi-tasking operating system.

A multi-tasking processing system according to the present invention comprises: a first event scheduler for causing a processor to execute processing whereby event processing units are generated by linking one or more events that are capable of being executed in the same context; a second event scheduler for causing a processor to execute processing of an event included in an event processing unit created by the first event scheduler and processing whereby event switching is performed that is not accompanied by context switching when execution of each event has been terminated; and a time-sharing system scheduler for executing the operations of the first and second event schedulers as tasks respectively on a processor.

A multi-tasking processing method according to the present invention includes: first event scheduling step for causing a processor to execute processing for generating event processing units by linking one or more events that are capable of being executed in the same context; second event scheduling step for causing a processor to execute processing of an event included in an event processing unit created by the first event scheduling step and processing whereby event switching is performed that is not accompanied by context switching when execution of each event has been terminated; and a time-sharing system scheduling step for executing the operations of the first and second event scheduling step as tasks respectively on a processor.

### BRIEF DESCRIPTION OF THE DRAWINGS

Other objects and advantages of the present invention will be described with reference to the following appended drawings.

FIG. 1 is a diagram showing the layer structure of a VoIP software switch according to a comparative example;

FIG. 2 is a diagram showing the functional structure of a VoIP software switch according to a comparative example;

FIG. 3 is a diagram given in explanation of time-sharing according to a comparative example;

FIG. 4 is a diagram showing the layer structure of a VoIP software switch according to an embodiment;

FIG. 5 is a diagram showing the functional structure of a call agent process of the embodiment;

FIG. 6 and FIG. 8 are flowcharts given in explanation of the operation of the embodiment;

FIG. 7 is a diagram given in explanation of time-sharing of the embodiment; and

FIG. 9 and FIG. 10 are diagrams given in explanation of the operating sequence of the embodiment.

### DESCRIPTION OF THE PREFERRED EMBODIMENTS

An embodiment of the present invention is described below with reference to the drawings. The size, shape and arrangement relationships of the various constituent components in the Figures are only shown diagrammatically to such an extent as to enable understanding of the present invention, and the numerical value conditions described below are given merely by way of example.

### Comparative Example

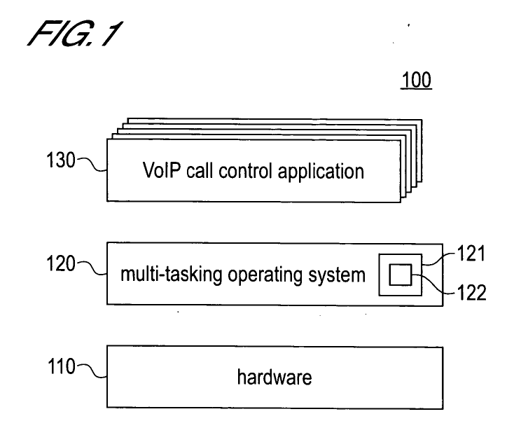

First of all, a comparative example corresponding to the present embodiment will be described with reference to FIG. 1 to FIG. 3. This comparative example is an example given to facilitate understanding of the characteristic features of the present invention and is not prior art. The comparative example is described taking as an example VoIP software switch constructed using a server computer running a multi-tasking operating system. A VoIP software switch is a switch for Internet telephony constructed of software on a computer.

FIG. 1 shows diagrammatically the layer construction of a VoIP software switch 100 according to the comparative example. As shown in FIG. 1, the VoIP software switch 100 comprises hardware 110, a multi-tasking operating system 120 and a VoIP call control application 130.

The hardware 110 is the hardware of a conventional server computer and includes for example a processor, cache memory and working memory, not shown.

The multi-tasking operating system 120 is a conventional operating system such as for example Windows or Linux. This operating system 120 realizes the basic functions as described above using a kernel 121. The kernel 121 includesa tlme-sharing system, not shown. The time-sharing system realizes multi-tasking using a TSS scheduler 122. As described above, a single task executes a single thread or a single process.

The VoIP call control application 130 is application software for making a server computer operate as a switch for Internet telephony.

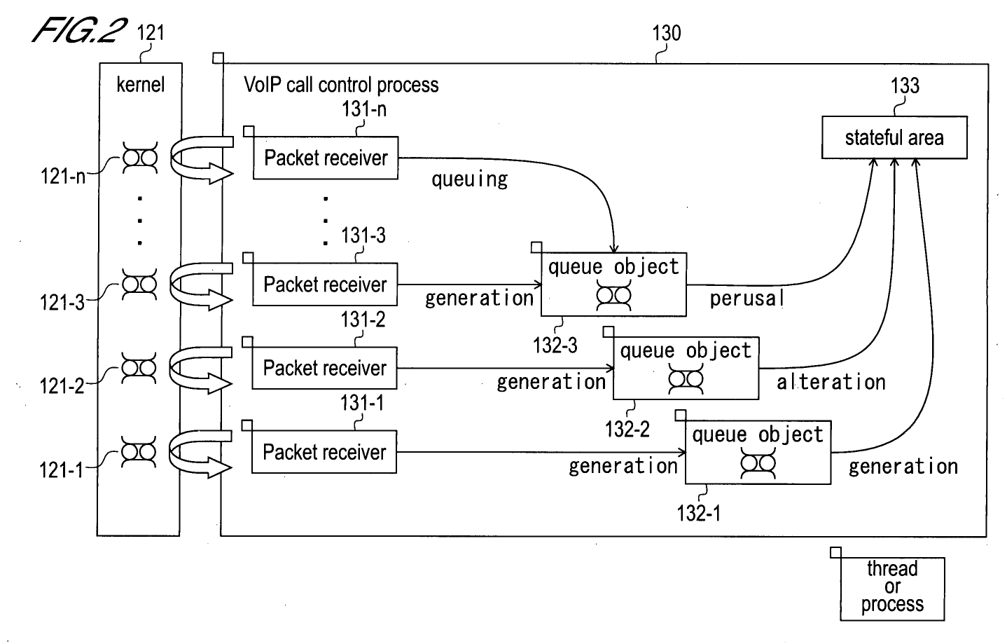

FIG. 2 shows diagrammatically the functional construction of a comparative example. Also, FIG. 2 shows a construction for performing call control. As shown in FIG. 2, the VoIP call control processes of the VoIP software switch 100 comprises packet receivers 131-1, 131-2, . . . , 131-n; queue objects 132-1, 132-2, . . . , 132-n and a stateful area 133.

The queues 121-1 to 121-n in the kernel 121 (see FIG. 1) receive communication packets, in which call control signals are stored, from the packet receivers 131-1 to 131-n, perform queuing, and subsequently return these communication packets to the packet receivers 131-1 to 131-n. When these communication packets are received, the packet receivers 131-1 to 131-n determine the call group to which the communication packets belong.

If no queue object corresponding to this call group exists, the packet receivers 131-1 to 131-n generate a new queue object. A queue object is generated corresponds to every call group. As the execution format of queue objects, an event-driven is adopted. The packet receivers 131-1 to 131-n queue events in the queue objects that have thus been generated. In this description, an “event” means call control.

The packet receivers 131-1 to 131-n queue events in the corresponding queue objects without generating new queue objects, when a queue object corresponding to the call group to which a received communication packet belongs is already present.

The queue objects 132-1 to 132-n sequentially execute the processing of queued events, under the control of the TSS scheduler 122. In a case where an event-driven is adopted, a single queue object constitutes a single thread or a single process. In other words, a single queue object is executed as a single task. Consequently, by adopting an event-driven, the response time of event processing can be shortened. However, in the case of call control, amounts of processing of a queue objects are extremely little, so in substantially all cases, the processing time of a single queue object is shorter than a single time quantum. As described above, when processing of a queue object has terminated, context switching is executed even before termination of the time quantum.

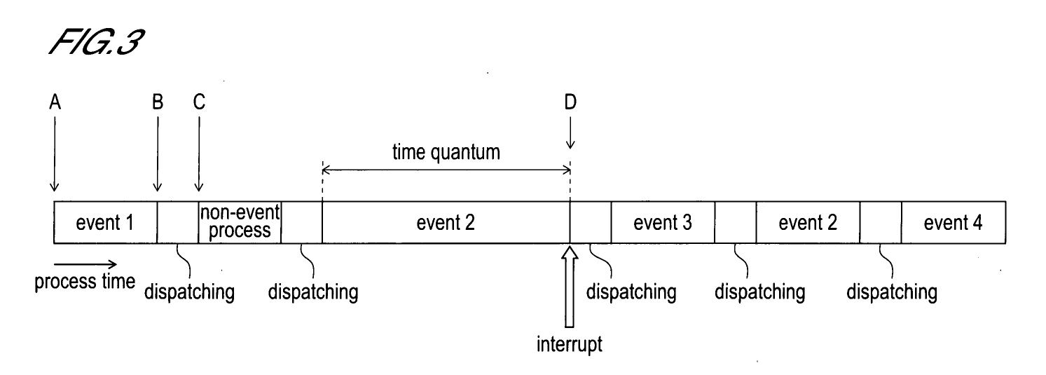

FIG. 3 shows the concept of processor time-sharing. As can be seen from FIG. 3, the TSS scheduler 122 executes a plurality of tasks for each time quantum. Any one or more of these tasks is allocated to call control.

As shown in FIG. 3, the processor initially starts to execute event 1 (see the time point A of FIG. 3).

In the example of FIG. 3, the event task processing terminates prior to the lapsed time reaching the time quantum. In this case, dispatching is executed (see the time point B of FIG. 3). Dispatching includes context switching, described above. When dispatching terminates, execution of the next task, that is non-event processing in the case of FIG. 3, is commenced (see time point C of FIG. 3).

In the case of the task processing of event 2, processing has not terminated by the time the lapsed time has reached the time quantum. In such a case, the TSS scheduler 122 (see FIG. 1) generates an interrupt (see the time point D of FIG. 3). Task processing of this event 2 is thereby interrupted, dispatching is executed, and processing of the next task (event 3 in the case of the example FIG. 3) is commenced. In the example of FIG. 3, recommencement of the execution of the interrupted event 2 occurs immediately after execution of the event 3. However, the timing of recommencement of the processing of the interrupted event 2 is variable and cannot be predicted.

As shown in FIG. 2, with execution of the events, the queue objects 132-1 to 132-n access the stateful area 133. The call control resources are stored in the stateful area 133. The queue objects 132-1 to 132-n i.e. the events frequently generate, alter and peruse these resources. As described above, if a plurality of tasks attempt to access the same resource region, locking is performed by the exclusion primitive function.

In substantially all cases in the VoIP software switch 100, the execution time of a single task is shorter than a single time quantum. Consequently, context switching is frequently performed. As described above, when context switching occurs frequently, the efficiency of user processes is lowered.

Also, as described above, the locking performed by the exclusion primitive function is a cause of delay or deadlocking of the user processes.

The problems related to context switching and the exclusion primitive function are solved by the present invention.

### Embodiment

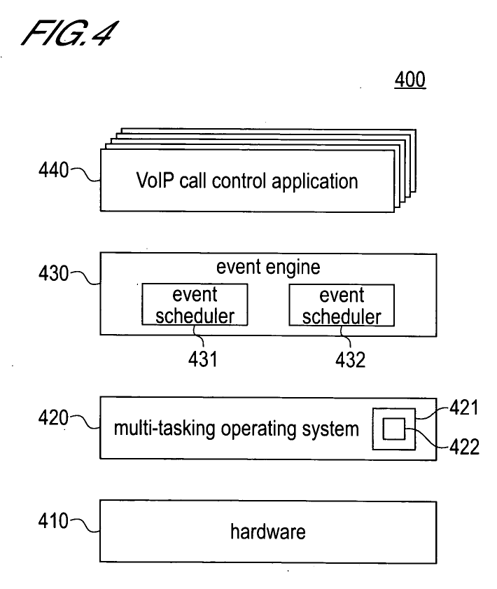

Next, a method and system according to the embodiment the present invention is described with reference to FIG. 4 to FIG. 10. The method and system according to the present embodiment are described taking as an example a VoIP software switch constructed using a server computer on which is loaded a multi-tasking operating system, in the same way as in the case of the comparative example described above.

FIG. 4 shows diagrammatically the layer structure of a VoIP software switch 400 according to the present embodiment. As shown in FIG. 4, the VoIP software switch 400 comprises hardware 410, a multi-tasking operating system 420, call control event engine 430, and VoIP call control application 440.

The hardware 410 is the hardware of a conventional server computer and includes a processor, cache memory and a working memory and other items, not shown, in the same way as in the case of the comparative example.

The multi-tasking operating system 420 is a conventional operating system such as in the case of the comparative example and includes a kernel 421, time-sharing system, not shown, and TSS scheduler 422.

The call control event engine 430 is software belonging to the user layer. The call control event engine 430 performs call agent processes (i.e. scheduling of call control). In the comparative example described above, scheduling of call control is performed by the TSS scheduler 122 (see FIG. 1). In contrast, in the present embodiment, the call control event engine 430 performs scheduling of call control. The call control event engine 430 is scheduled by the TSS scheduler 422. In other words, in the present embodiment, the TSS scheduler 422 may be considered as performing scheduling of call control through the call control event engine 430, not as directly performing scheduling of call control. The call control event engine 430 comprises one or a plurality of event schedulers. The present embodiment is described taking as an example the case where two event schedulers 431, 432 are used. The event schedulers 431, 432 provide the context for the TSS scheduler 422. As will be described, the event schedulers 431, 432 have the same software construction, but the processing that is executed (i.e. the processing that is the subject of the scheduling) is different.

The VoIP call control application 440 is application software for causing the server computer to operate as a switch for Internet telephony. The VoIP call control application 440 executes processing of a plurality of types including call control. When the VoIP call control application 440 executes call control, the VoIP call control application 440 is scheduled by the event schedulers 431, 432 (more precisely, the VoIP call control application 440 is scheduled by the TSS scheduler 422 through the event schedulers 431, 432). In contrast, when the VoIP call control application 440 performs processing other than call control, the VoIP call control application 440 is directly scheduled by the TSS scheduler 422.

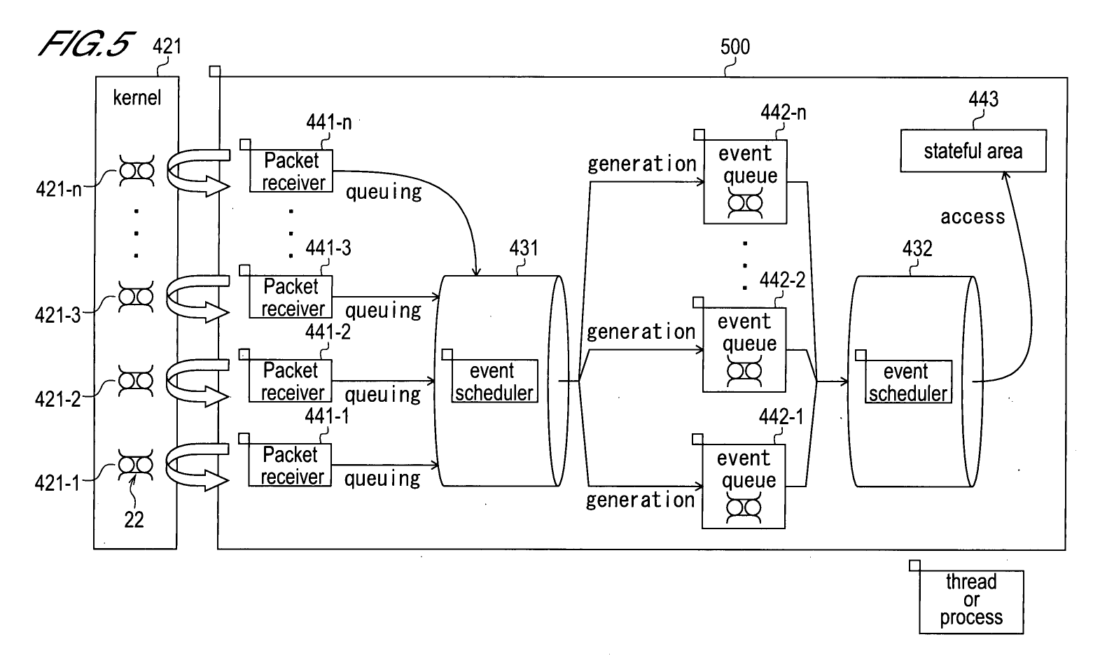

FIG. 5 shows diagrammatically the functional structure of the call agent process. As shown in FIG. 5, the call agent process 500 comprises event schedulers 431, 432, packet receivers 441-1, 441-2, . . . , 441-n, event queue management objects 442-1, 442-2, . . . , 442-n, and a stateful area 443. From the viewpoint of software, the event schedulers 431, 432 are constituted by the event engine 430 and from the viewpoint of hardware by a processor. From the viewpoint of software, the packet receivers 441-1 to 441-n and event queue management object 442-1 to 442-n are constituted by the call control application 440 and from the viewpoint of hardware by a processor. From the viewpoint of software, the stateful area 443 is constituted by the VoIP call control application 440 and from the viewpoint of hardware by working memory. In the same way as in the case of the comparative example described above, the kernel 421 comprises queues 421-1, 421-2, . . . , 421-n.

A detailed description of the structural elements shown in FIG. 5 is given hereinafter.

The queues 421-1 to 421-n in the kernel 421 (see FIG. 4) receive communication packets in which call control signals are stored from the packet receivers 441-1 to 441-n, queue theses packet and, after that, return these packet to the packet receivers 441-1 to 441-n.

The packet receivers 433-1 to 433-n receive the communication packets in which the call control signals are stored, transfer them to kernel 421. The packet receivers 433-1 to 433-n also receive communication packets that are returned from the kernel 421. The packet receivers 131-1 to 131-n identify the call group to which the received communication packets belong. If no queue object exists corresponding to this call group, the packet receivers 131-1 to 131-n generate a new queue object. A queue object of the call control signal is generated for each call group. In regard to a called control signal, a queue object is generated for each called group. Events are queued in the queue objects generated by the packet receivers 131-1 to 131-n. In this description, an “event” means a call control. If a queue object corresponding to this call group already exists, the packet receivers 131-1 to 131-n queue the events in the corresponding queue object without generating a new queue object.

The event scheduler 431 performs scheduling for causing the processor to generate an event thread. First of all, the event scheduler 431 gets a queue object from a packet receiver 433-1 to 433-n. The event scheduler 431 then generates a thread from a single or a plurality of queue objects. In the comparative example described above, a single thread was always constituted by a single queue object. In contrast, in the present embodiment, a single thread can be generated from a plurality of queue objects. In this way, the processing efficiency of a VoIP software switch according to the present embodiment is increased compared with the processing efficiency of a VoIP software switch according to the comparative example. The reason why the processing efficiency of a VoIP software switch according to the present embodiment is excellent is described below. In addition, if a single thread is generated from a plurality of queue objects, the total number of threads that are processed by the event scheduler 432, to be described later, is reduced. For reasons to be described later, reducing the number of threads decreases the frequency of generation of locking, so the efficiency of processing can be improved and deadlocking can be suppressed.

The event queue management objects 442-1 to 442-n queue the events delivered to the event scheduler 432 from the event scheduler 431, for each thread. The event queue management objects 442-1 to 442-N have a FIFO (first-in first-out) structure.

The event scheduler 432 performs scheduling for making the processor process threads. In other words, the event scheduler 432 gets a thread from an event queue management object 442-1 to 442-n and causes the processing of the events contained in this thread to be executed by the processor. In the present embodiment, a plurality of events may be contained in a single thread. Consequently, the event scheduler 432 may execute a plurality of events in a single task process. The event scheduler 432 determines the processing sequence of events by binding the thread that it has obtained with the event queue management objects 442-1 to 442-n. Each event accesses the stateful area 443. The call control resources are stored in the stateful area 443. The events frequently generate, alter or peruse these resources. As described above, when a plurality of tasks attempt to access the same resource region, locking may be generated by the exclusion primitive function. The event scheduler 432 comprises a hang check thread. The hang check thread detects deadlocking i.e. hang up of the processor by the method to be described.

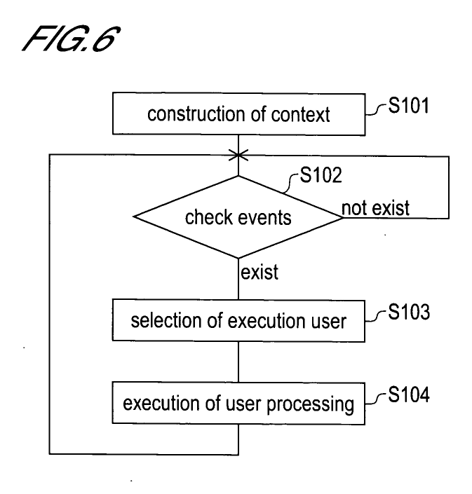

Next, the event schedulers 431, 432 will be described in more detail with reference to FIG. 6 to FIG. 8.

As described above, the event schedulers 431, 432 execute different processing but are identical in terms of their software construction. These event schedulers 431, 432 respectively comprise one or more monitoring threads. The monitoring thread generates a user execution thread for executing an event (i.e. call control) and a hang check thread that monitors for the occurrence of deadlock.

FIG. 6 is a flow chart showing the operation of the user execution thread.

The user execution thread first of all constructs a context for execution of an event thread (see step S101 of FIG. 6). As described above, the context is the execution environment of the thread.

Next, the user execution thread performs a check to establish whether or not the event to be executed exists (see step S102 of FIG. 6). If the event to be executed does not exist, user execution shifts to a standby condition and the check for the existence of the event is repeated.

If the event to be executed does exist, the user execution thread selects the execution user (see step S103 in FIG. 6). In the case of the event scheduler 431, the “execution user” is an event queue management object that queues the event thread. In contrast, in the case of the event scheduler 432, the execution user is a task corresponding to the event thread.

Next, the user execution thread executes user processing (see step S104 in FIG. 6). User processing is processing to make the processor perform generation of an event thread in the event scheduler 431. As described above, the event scheduler 431 generates a single event thread from a plurality of queue objects. In contrast, the user processing in the event scheduler 432 is processing to cause a processor to execute an event. As described above, the event scheduler 432 causes the processor to execute a single event thread as a single task. In many cases, a single event thread includes a plurality of events.

As can be seen from FIG. 6, after construction of the context in step S101, the processing of step S102 to S104 is repeated. In other words, the processing of steps S102 to S 104 is repeated so long as the VoIP software switch is operating in the same context. As described above, the operation of the event schedulers 431, 432 is scheduled by the TSS scheduler 422. In other words, the event schedulers 431, 432 are executed as one of the tasks that is changed over by the TSS scheduler 422. Dispatching is performed in the case of task changeover (i.e. changeover of the execution thread) by the TSS scheduler 422. Task changeover by the TSS scheduler 422 therefore accompanies execution of context switching.

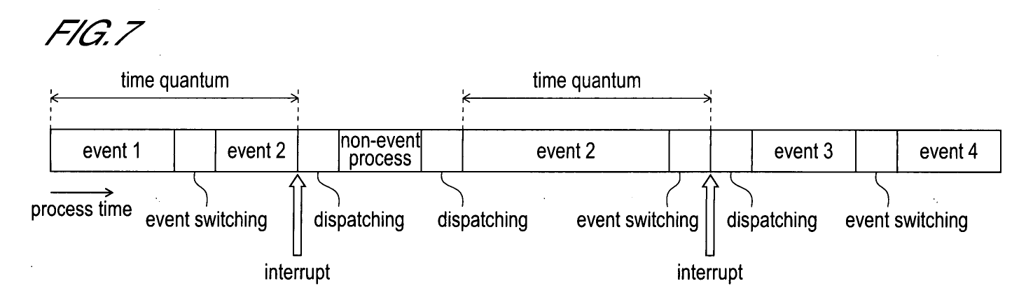

FIG. 7 shows the relationship of scheduling by the TSS scheduler 422 with scheduling by the event scheduler 432. In FIG. 7, events E1 to E4 belong to the same event thread.

As can be seen from FIG. 7, in the present embodiment, dispatching is performed at each time quantum. In addition, in the case that processing of an event terminates during a single time quantum, event switching is performed.

As described above, dispatching is processing for changing over the task that is performed by the TSS scheduler 422. As described above, since dispatching accompanies context switching, the time for which it monopolizes the processor is long.

Event switching is processing for changing over the event that is executed within the task executed by the event scheduler 432. As shown in FIG. 6, the monitoring thread of the event schedulers 431, 432 is only executed on commencement of processing for generating the context: there is no need to perform context switching when the event that is being executed is changed over in step S103. Thus event switching is not accompanied by context switching, so the time for which the processor is monopolized is shorter than in the case of dispatching.

In the comparative example described above, dispatching was performed every time a single event terminated (see FIG. 3). In contrast, in the present embodiment, since a single thread can be formed by a plurality of events, in many cases, the event switching is executed when the processing of an event terminates within the time quantum. In the present embodiment, the execution interval of dispatching is shorter than the time quantum only in the case where the processing of an event terminates within the time quantum and no longer remains some event that should be executed. The efficiency of processing by the processor in the present embodiment can therefore be improved, compared with the comparative example described above.

When a single thread is generated from a plurality of queue objects, the total number of threads that are processed by the event scheduler 432, to be described later, is reduced. As described above, when a thread attempts to access a resource region that is being accessed by another thread, the thread is blocked by the exclusion primitive function. When a thread is locked, the thread is not executed and only dispatching is performed. Consequently, increase in the number of locked threads results in a corresponding decrease in processing efficiency of the processor. In addition, there is a risk of other threads being locked if such threads attempt to access a resource region for which the locked thread had a priority right. Thus, when the number of locked threads increases, ultimately, deadlock results. In contrast, in the case of the present embodiment, since the number of threads is smaller than in the case of the comparative example, locking produced by the exclusion primitive function is unlikely to occur. In addition, the smaller the number of threads, the easier is it to recover from deadlock and the time required for recovery is shorter. Consequently, with the present embodiment, the efficiency of processing by the processor can be increased and the operation of the VoIP software switch can be stabilized.

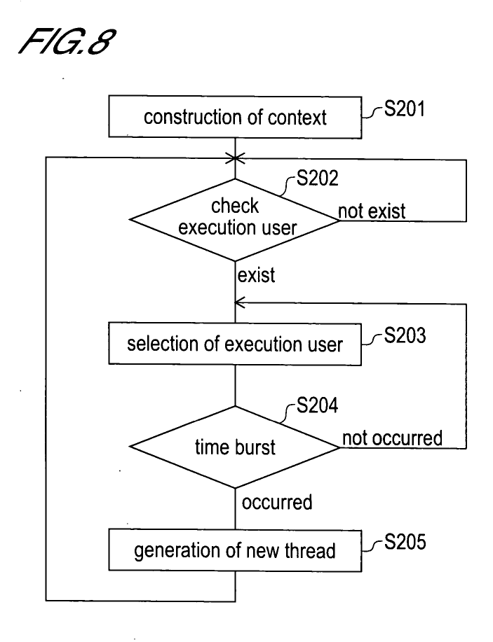

FIG. 8 is a flow chart showing the operation of a hang check thread provided in the event schedulers 431, 432.

First of all, the hang check thread constructs a context for execution of this hang check thread (see step S201 of FIG. 8).

Next, the hang check thread checks whether or not user processing currently being executed is present (see step S202 of FIG. 8). User processing means processing to make processor to generate an event thread in the case of event scheduler 431, and processing to make processor to execute an event in the case of the event scheduler 432. If no user processing currently being executed is present, the hang check thread shifts to a standby condition in which a check for existence of user processing that is being executed is repeated.

If user processing being executed is present, the hang check thread acquires the time stamp after selection of the initial user process (see step S203 in FIG. 8). The time stamp that is initially acquired in respect of this user process is stored as data indicating the commencement time point of this user process.

Next, the hang check thread ascertains the lapsed time from commencement of processing by comparing the time stamp with the time-point of commencement of processing (see step S204 in FIG. 8). Then, if this lapsed time has not exceeded a prescribed time, the thread returns to step S203 and selects the next user process and acquires its time stamp.

In step S204, if the lapsed time has exceeded the prescribed time, the thread concludes that a time burst has occurred.

If a time burst has occurred, the hang check thread generates a new thread in place of the thread that is executing this user processing, and constructs a context for executing this new thread (see step S205 in FIG. 8). After this, the hang check thread returns to step S202.

If a large number of time bursts are generated in a short time, there is a high probability of occurrence of deadlock. Consequently, if the frequency of generation of new threads exceeds a prescribed threshold value, the event schedulers 431, 432 preferably assume that the deadlock has occurred and reset the process.

Also, the monitoring thread of the event schedulers 431, 432 detects occurrence of event congestion. The monitoring thread concludes that congestion is occurring if the number of events that are queued therein exceeds a prescribed threshold value. The monitoring thread may then generate a new thread in place of the user execution thread in respect of which congestion was generated. However, when congestion occurs, rather than generating a new thread, it is desirable that the monitoring thread itself should change to a user execution thread. This is because, when congestion occurs, securing resources for generating a new thread or guaranteeing the operation of a new thread may sometimes be difficult. The monitoring thread operates with priority over other threads and so securing of resources and normal operation can easily be performed.

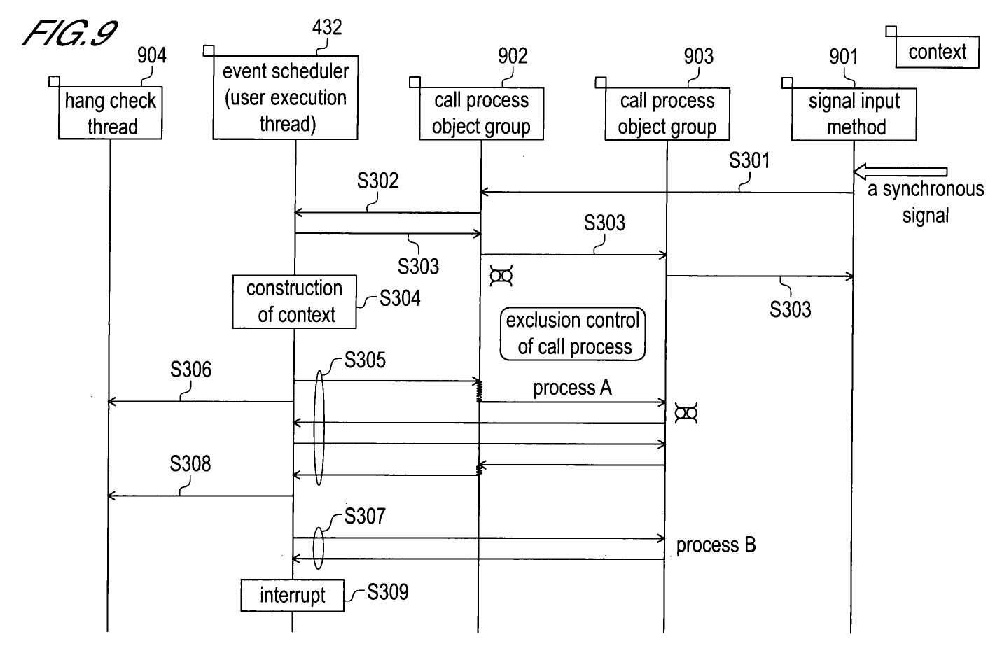

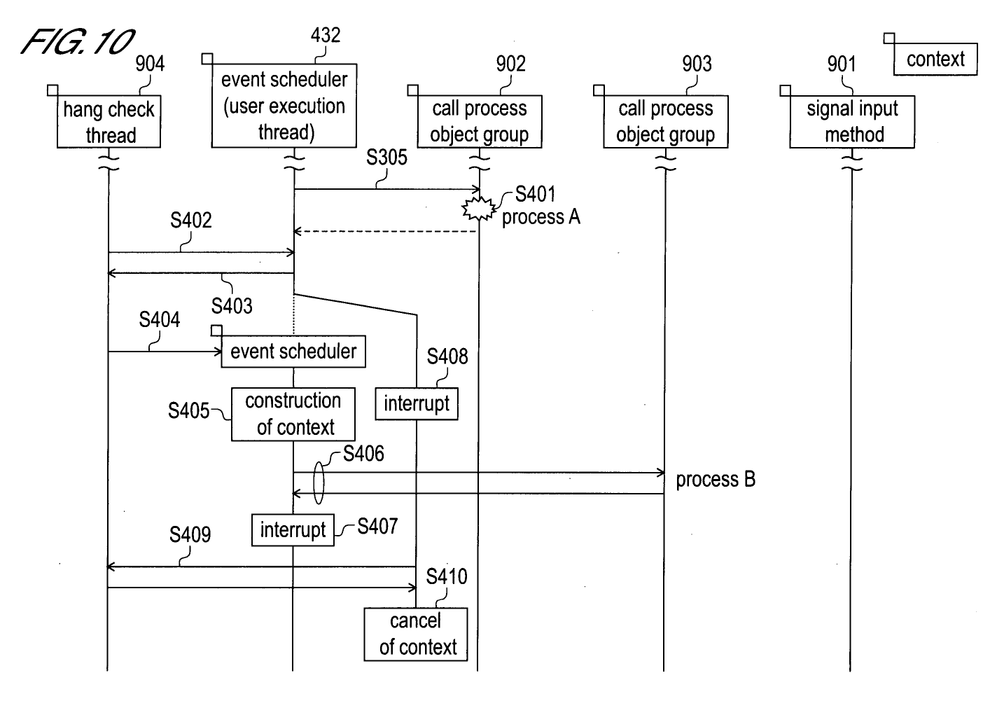

Next, the operating sequence of the event scheduler 432 will be described with reference to FIG. 9 and FIG. 10.

FIG. 9 shows the sequence when the event scheduler 432 is operating normally.

In FIG. 9, the signal input method 901 is a function whereby the event queue management objects 442-1 to 442-n input a signal from the event scheduler 431. The call process object group 902 is a group of call process objects related to a subscriber who made a call; the call process object group 903 is the group of call process objects related to a subscriber who receives the call. The call process object groups 902, 903 are respectively implemented by one or other of the event queue management objects 442-1 to 442-n. As described above, the hang check thread 904 is a thread that is processed by the event scheduler 432.

First of all, the signal input method 901 calls the call process object group 902 (see step S301 of FIG. 9). When the signal input object of the call process object group 902 receives this call, it generates a signal requesting context. This request signal is queued in the event queue management object before being sent to the event scheduler 432 (see step S302 of FIG. 9). When the request signal is queued, the signal input method 901 and call process object groups 902, 903 execute, in exclusive fashion, processing relating to this call (see step S303 of FIG. 9).

When the event scheduler 432 receives the request signal, the user execution thread constructs a context and executes processing corresponding to this request signal (see step S304 and S305 in FIG. 9, and FIG. 6). Hereinbelow, this processing will be termed “process A”. When process A is commenced, the hang check thread 904 stores the start time and commences hang checking (see step S306 of FIG. 9 and FIG. 8).

Accompanying the execution of process A, the event scheduler 432 performs exchange of signals with the call process object groups 902 and 903.

Sometimes an asynchronous event may be generated corresponding to an object in the call process object group 903 when the process A is being executed. Hereinbelow, the processing corresponding to this asynchronous event will be termed process B. In this case, the call process object group 903 interrupts the operation relating to process A and queues a signal to request the structure of the context for process B. The request signal relating to the process B is then sent to the event scheduler 432. When the event scheduler 432 receives the request signal of process B, it returns a signal indicating that it has received this request to the call process object group 903. When the call process object group 903 receives this reply signal, process A is recommenced.

When process A terminates, the event scheduler 432 constructs a context relating to process B and starts process B (see step S307 of FIG. 9). Also on the commencement of process B, the hang check thread 904 stores the start time and starts the hang check (see step S308 in FIG. 9).

After this, when the time quantum terminates, an interrupt is generated by the TSS scheduler 422, and execution of the task is thereby interrupted (see step S309 of FIG. 9).

FIG. 10 shows the sequence when abnormality occurs while the event scheduler 432 is operating.

In the sequence of FIG. 10, the processing of step S301 to S306 is the same as in the case FIG. 9, so the description thereof is not repeated.

The case where abnormality occurs during execution of process A will now be considered (see step S401 of FIG. 10). Abnormality occurs due to for example stopping of a program due to deadlock or an infinite loop produced by a logical inconsistency.

As shown in FIG. 8, the hang check thread 904 periodically monitors the lapsed time of process A (see step S402 of FIG. 10). If, then, the lapsed time of processing exceeds the prescribed time, the hang check thread 904 decides that a time burst has occurred (see step 403 in FIG. 10 and FIG. 8). The processing when a time burst has occurred is different when the time burst is detected prior to termination of the time quantum and when the time burst is detected on restarting of processing.

If the time burst is detected prior to termination of the time quantum relating to process A, the hang check thread 904 generates a new user execution thread in place of the user execution thread in which the time burst occurred (see step S404 of FIG. 10). The new thread generates a context and continues processing (see step S405 of FIG. 10).

Just as in the case of FIG. 9, when process A terminates, this new thread performs execution of process B (see step S406 of FIG. 10). After this, when the time quantum terminates, an interrupt is generated by the TSS scheduler 422 and execution of the task is thereby interrupted (see step S407 of FIG. 10) If no time burst has been detected by the time that the time quantum relating to process A finishes, the following processing is executed.

If no time burst has been detected by the time that the time quantum relating to process A finishes, execution of the task is interrupted by means of an interrupt generated by the TSS scheduler 422 (see step S408 of FIG. 10).

When the next time quantum of this task is commenced, the hang check thread 904 ascertains whether or not the context can be continued (see step S409 of FIG. 10). If it is then found that congestion is generated, the hang check thread 904 concludes that the context should not be continued and cancels this context (see step S410 of FIG. 10). After this, generation of the context by the event scheduler 432 is performed and process A is recommenced.

The operating sequence of the event scheduler 431 is basically the same as that of the event scheduler 432 and further description thereof is therefore dispensed with. The functioning of the hang check threads of the event schedulers 431, 432 can be disabled. It is therefore possible to disable the functioning of the hang check threads if the likelihood that the processing of the event scheduler 431 will generate a time burst is extremely low.

Since, according to the present embodiment, a single thread can be formed by a plurality of events, the probability of event switching being executed when the processing of an event has terminated within the time quantum is high. Consequently, in the present embodiment, the processing efficiency of the processor can be improved compared with the comparative example described above.

In the present embodiment, a single thread is generated from a plurality of queue objects, so the total number of threads that are processed by the event scheduler becomes fewer, so locking is unlikely to occur. Consequently, with the present embodiment, the efficiency of processing by the processor can be improved and the operation of the VoIP software switch can be stabilized.

In addition, in the present embodiment, since a hang check thread 904 is employed, recovery of the system can be achieved in a short time on detection of occurrence of a time burst.

In the present embodiment, the description was given taking as an example application of the present invention to a VoIP software switch of the call agent type; however, it would also be possible to apply the present invention to VoIP software switches of other types such as for example a media gateway controlled type.

What is claimed is:

1. A multi-tasking processing system comprising:
a first event scheduler for causing a processor to execute processing for generating an event processing unit by linking one or a plurality of events capable of execution under the same context;
a second event scheduler for causing a processor to execute processing of the events included in the event processing unit created by the first event scheduler and processing for performing event switching not accompanied by context switching when the execution of each event is terminated; and
a time-sharing system scheduler for causing a processor to execute as tasks respectively the operation of the first and second event schedulers.

2. The multi-tasking processing system according to claim 1, wherein the events are call-control events of a VoIP software switch.

3. The multi-tasking processing system according to claim 2, wherein the event processing unit is generated by linking a plurality of events relating to a series of processes when a call is made from one telephone to another telephone.

4. The multi-tasking processing system according to claim 1, wherein the events are called-control events of a VoIP software switch.

5. The multi-tasking processing system according to claim 4, wherein the processing unit is generated by linking a plurality of events relating to a series of processes when one telephone is called from another telephone.

6. The multi-tasking processing system according to claim 1, wherein the first and second event schedulers generate a monitoring processing unit for monitoring execution of events.

7. The multi-tasking processing system according to claim 6, wherein the monitoring processing unit generates a user execution processing unit for executing events.

8. The multi-tasking processing system according to claim 7, wherein the user execution processing unit causes the processor to sequentially execute the events after the context is constructed.

9. The multi-tasking processing system according to claim 7, wherein the monitoring processing unit further generates a hang check processing unit that checks for a time burst of the user execution processing unit.

10. The multi-tasking processing system according to claim 9, wherein the hang check processing unit measures the lapsed time from commencement of processing of the event by the user execution processing unit and determines that a time burst has occurred if the lapsed time reaches a prescribed threshold value.

11. The multi-tasking processing system according to claim 10, wherein the hang check processing unit generates a new user execution processing unit for executing the event if a time burst is generated.

12. The multi-tasking processing system according to claim 7, wherein the monitoring processing unit determines that congestion is generated if the number of events that are queued therein exceeds a prescribed threshold value.

13. The multi-tasking processing system according to claim 12, wherein the monitoring processing unit generates a new user execution processing unit for executing the event if congestion is generated.

14. The multi-tasking processing system according to claim 12, wherein the monitoring processing unit changes to the user execution processing unit if congestion is generated.

15. The multi-tasking processing system according to claim 1, wherein the processing unit is a thread that is executed by the operating system.

16. The multi-tasking processing system according to claim 1, wherein the processing unit is a process that is executed by the operating system.

17. The multi-tasking processing system according to claim 1, wherein the time-sharing system scheduler is a scheduler of a time-sharing system provided in the kernel of the multi-tasking operating system.

18. A multi-tasking processing method containing:
a first event scheduling step for causing a processor to execute processing for generating an event processing unit by linking one or a plurality of events capable of execution under the same context;
a second event scheduling step for causing a processor to execute processing of the events included in the event processing unit created by the first event scheduling step and processing for performing event switching not accompanied by context switching when the execution of each event is terminated; and
a time-sharing system scheduling step for causing a processor to execute as tasks respectively the operation of the first and second event scheduling steps.

19. The multi-tasking processing method according to claim 18, wherein the events are call-control events of a VoIP software switch.

20. The multi-tasking processing method according to claim 19, wherein the event processing unit is generated by linking a plurality of events relating to a series of processes when a call is made from one telephone to another telephone.

21. The multi-tasking processing method according to claim 18, wherein the events are called-control events of a VoIP software switch.

22. The multi-tasking processing method according to claim 21, wherein the processing unit is generated by linking a plurality of events relating to a series of processes when one telephone is called from another telephone.

23. The multi-tasking processing method according to claim 18, wherein the first and second event scheduling steps generate a monitoring processing unit for monitoring execution of events.

24. The multi-tasking processing method according to claim 23, wherein the monitoring processing unit generates a user execution processing unit for executing events.

25. The multi-tasking processing method according to claim 24, wherein the user execution processing unit causes the processor to sequentially execute the events after the context is constructed.

26. The multi-tasking processing method according to claim 24, wherein the monitoring processing unit further generates a hang check processing unit that checks for a time burst of the user execution processing unit.

27. The multi-tasking processing method according to claim 26, wherein the hang check processing unit measures the lapsed time from commencement of processing of the event by the user execution processing unit and determines that a time burst has occurred if the lapsed time reaches a prescribed threshold value.

28. The multi-tasking processing method according to claim 27, wherein the hang check processing unit generates a new user execution processing unit for executing the event if a time burst is generated.

29. The multi-tasking processing method according to claim 28, wherein the monitoring processing unit determines that congestion is generated if the number of events that are queued therein exceeds a prescribed threshold value.

30. The multi-tasking processing method according to claim 29, wherein the monitoring processing unit generates a new user execution processing unit for executing the event if congestion is generated.

31. The multi-tasking processing method according to claim 29, wherein the monitoring processing unit changes to the user execution processing unit if congestion is generated.

32. The multi-tasking processing method according to claim 18, wherein the processing unit is a thread that is executed by the operating system.

33. The multi-tasking processing method according to claim 18, wherein the processing unit is a process that is executed by the operating system.

34. The multi-tasking processing method according to claim 18, wherein the time-sharing system scheduling step is a scheduler of a time-sharing system provided in the kernel of the multi-tasking operating system.
